(19) United States
(12) Patent Application Publication
(10) Pub. No.: US 2007/0018979 A1
(43) Pub. Date: Jan. 25, 2007

(54) VIDEO DECODING WITH 3D GRAPHICS SHADERS

(75) Inventor: Madhukar Budagavi, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/459,687

(22) Filed: Jul. 25, 2006

Related U.S. Application Data
(60) Provisional application No. 60/702,543, filed on Jul. 25, 2005.

(51) Int. Cl. G06T 15/50

(52) U.S. Cl. 345/426

(57) ABSTRACT

Video coding using 3D graphics rendering hardware by enhancing pixel shaders to pixel block shaders to provide efficient motion compensation computations. Reference frame prediction corresponds to texture lookup, and matrix multiplication is cast in linear combinations of rows format to correspond to pixel shader vector operations.

### CROSS-REFERENCE TO RELATED APPLICATIONS

This application claims priority from provisional Appl. No. 60/702,543, filed Jul. 25, 2005. The following patent application disclose related subject matter: application Ser. No. ______, filed ______. (TI-38612)

### BACKGROUND OF THE INVENTION

The present invention relates to video coding, and more particularly to computer graphics rendering adapted for video decoding.

There are multiple applications for digital video communication and storage, and multiple international standards have been and are continuing to be developed. H.264/AVC is a recent video coding standard that makes use of several advanced video coding tools to provide better compression performance than existing video coding standards such as MPEG-2, MPEG-4, and H.263. At the core of all of these standards is the hybrid video coding technique of block motion compensation prediction plus transform coding of prediction residuals. Block motion compensation is used to remove temporal redundancy between successive images (frames), whereas transform coding is used to remove spatial redundancy within each frame. FIGS. 2a-2b illustrate H.264/AVC functions which include a deblocking filter within the motion compensation loop to limit artifacts created at block edges.

Interactive video games use computer graphics to generate images according to game application programs. FIG. 2c illustrates typical stages in computer graphics rendering which displays a two-dimensional image on a screen from an input application program that defines a virtual three-dimensional scene. In particular, the application program stage includes creation of scene objects in terms of primitives (e.g., small triangles that approximate the surface of a desired object together with attributes such as color and texture); the geometry stage includes manipulation of the mathematical descriptions of the primitives; and the rasterizing stage converts the three-dimensional description into a two-dimensional array of pixels for screen display.

FIG. 2d shows typical functions in the geometry stage of FIG. 2c. Model transforms position and orient models (e.g., sets of primitives such as a mesh of triangles) in model/object space to create a scene (of objects) in world space. A view transform selects a (virtual camera) viewing point and direction for the modeled scene. Model and view transforms typically are affine transformations of the mathematical descriptions of primitives (e.g., vertex coordinates and attributes) and convert world space to eye space. Lighting provides modifications of primitives to include light reflection from prescribed light sources. Projection (e.g., a perspective transform) maps from eye space to clip space for subsequent clipping to a canonical volume (normalized device coordinates). Screen mapping (viewport transform) scales to x-y coordinates for a display screen plus a z coordinate for depth (pseudo-distance) that determines which (portions of) objects are closest to the viewer and will be made visible on the screen. Rasterizing provides primitive polygon interior fill from vertex information; e.g., interpolation for pixel color, texture map, and so forth.

Programmable hardware can provide very rapid geometry stage and rasterizing stage processing; whereas, the application stage usually runs on a host general purposed processor. Geometry stage hardware may have the capacity to process multiple vertices in parallel and assemble primitives for output to the rasterizing stage; and the rasterizing stage hardware may have the capacity to process multiple primitive triangles in parallel. FIG. 2e illustrates a geometry stage with parallel vertex shaders and a rasterizing stage with parallel pixel shaders. Vertex shaders and pixel shaders are essentially small SIMD (single instruction multiple dispatch) processors running simple programs. Vertex shaders provide the transform and lighting for vertices, and pixel shaders provide texture mapping (color) for pixels in the triangles defined by the vertices. FIGS. 2f-2g illustrate pixel shader architecture.

Cellphones that support both video coding and 3D graphics capabilities are expected to be available in the market in the near future. For example, Texas Instruments has introduced processors such as the OMAP2420 for use in such cellphones; see FIG. 3a. Intel® has also recently introduced a processor for use in such cellphones—the 2700G multimedia accelerator. FIG. 3a shows the various components present in the OMAP 2420 processor.

However, these applications have the problems of complexity, memory bandwidth, and compression trade-offs in 3D rendering of video clips.

### SUMMARY OF THE INVENTION

The present invention provides a pixel shader extended for video or image decoding. Video decoding may adapt texture lookup for reference frame interpolation.

### BRIEF DESCRIPTION OF THE DRAWINGS

FIG. 1 illustrates a preferred embodiment.

FIGS. 2a-2g are functional block diagrams for video coding and computer graphics.

FIGS. 3a-3b show a processor and network communication.

FIG. 4 illustrates pixel shader operations.

FIG. 5 shows bilinear interpolation.

FIGS. 6-7 show texture operations.

### DESCRIPTION OF THE PREFERRED EMBODIMENTS

### 1. Overview

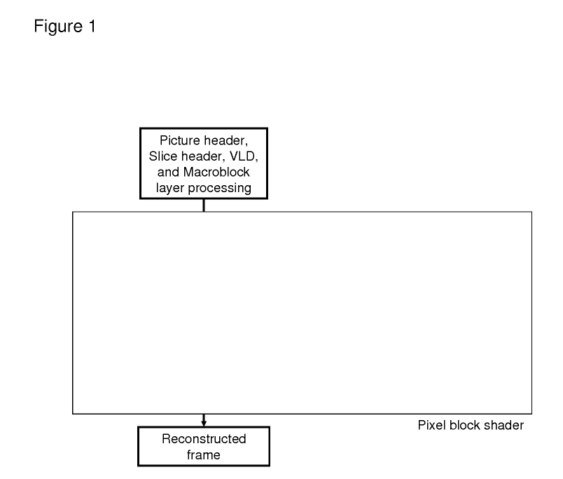

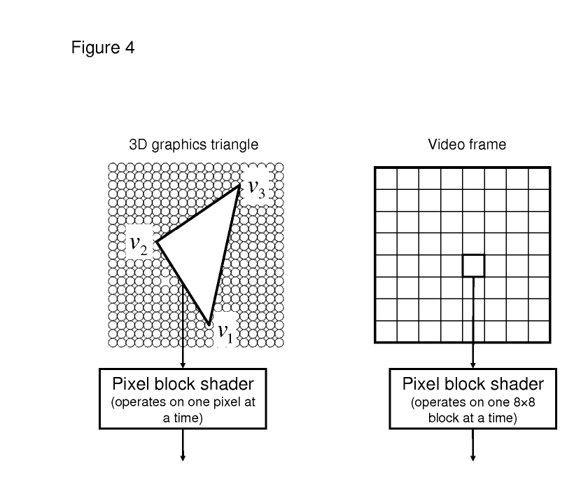

Preferred embodiment codecs and methods provide video coding using pixel shaders extended with block operations. FIG. 1 shows an architecture and FIG. 4 illustrates two operation modes: single pixels for graphics and 8×8 blocks of pixels for video coding.

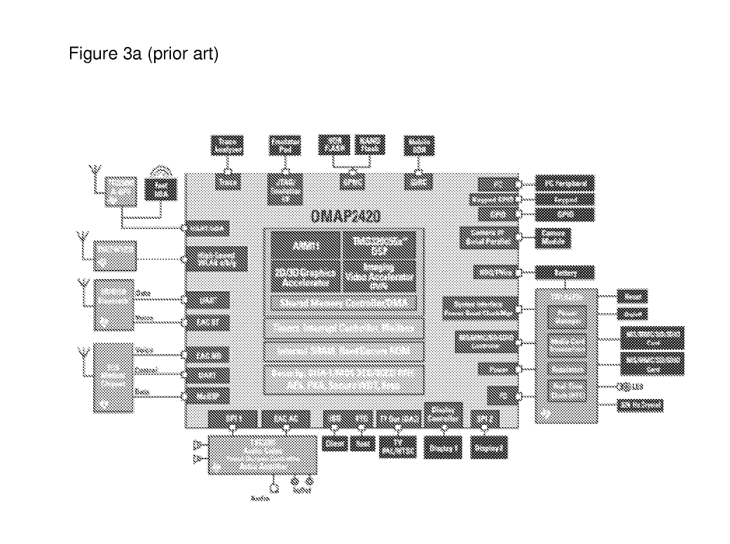

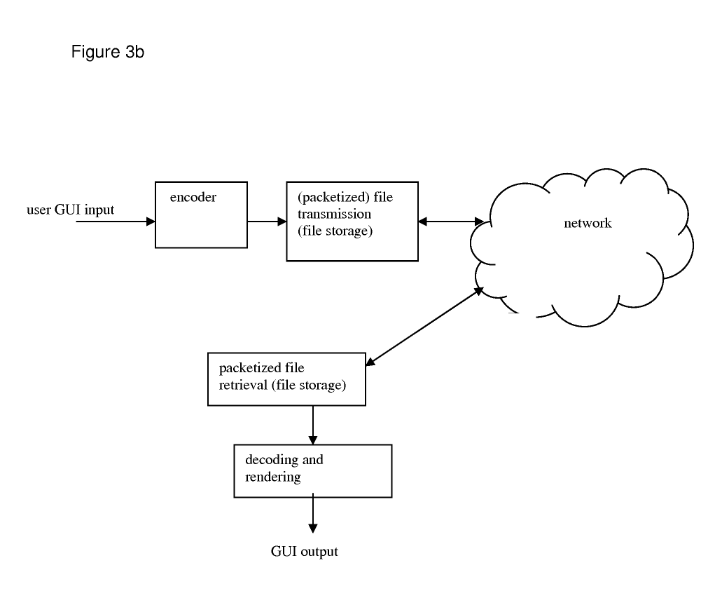

Preferred embodiment systems such as cellphones, PDAs, notebook computers, etc., perform preferred embodiment methods with any of several types of hardware: digital signal processors (DSPs), general purpose programmable processors, application specific circuits, or systems on a chip (SoC) such as combinations of a DSP and a RISC processor together with various specialized programmable accelerators which include pixel shaders (e.g., FIG. 3a). A stored program in an onboard or external (flash EEP)ROM or FRAM could implement the signal processing. Analog-to-digital converters and digital-to-analog converters can provide coupling to the real world, modulators and demodulators (plus antennas for air interfaces) can provide coupling for transmission waveforms, and packetizers can provide formats for transmission over networks such as the Internet as illustrated in FIG. 3b.

### 2. Preferred Embodiment Strategy

The processor of FIG. 3a has separate processing blocks for 3D graphics acceleration and for video coding acceleration. Preferred embodiment architectures provide for a unified processing block that can run both 3D graphics and video codecs. This architecture minimizes the redundancies between the 3D graphics and video coding blocks and hence can lead to a savings of silicon area for processors that need to support both 3D graphics and video coding. The common architecture is an extension of pixel shaders used in modern 3D graphics processors. Consider the example of MPEG-4 video decoding to illustrate the preferred embodiment extensions to pixel shaders. The common architecture can be further expanded to support other image and video codecs.

First, this section provides a brief overview of the processing pipelines typically used for 3D graphics and for video coding. Then section 3 presents the preferred embodiment architecture and extensions to pixel shaders to support both video decoding and 3D graphics.

3D graphics rendering deals with displaying 2D images that result from a projection of the 3D world onto a plane of projection (viewing plane). The 3D world is composed of various 3D models that are arranged in space with respect to each other. The 3D models are usually represented by a mesh of triangles that cover the 3D model surface. Each triangle consists of 3 vertices. Each vertex has several attributes such as the geometric (homogeneous) coordinates (x, y, z, w), the color (and transparency) coordinates (r, g, b, a), and the texture coordinates (s, t, r, q). For humanoid models, typically around 1000 triangles are required to represent the humanoid surface.

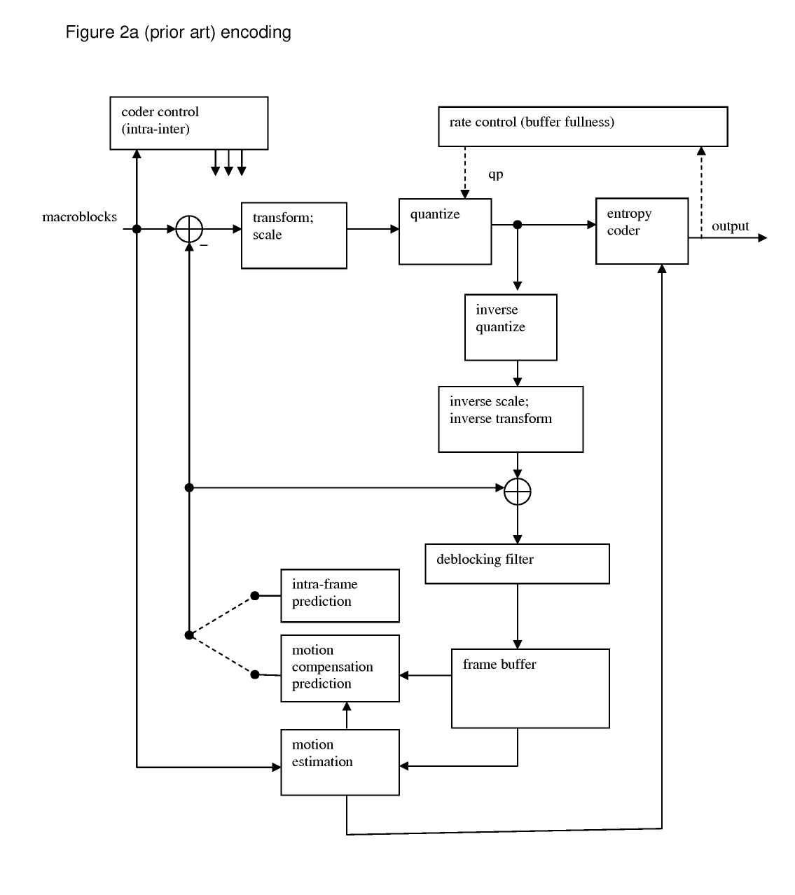

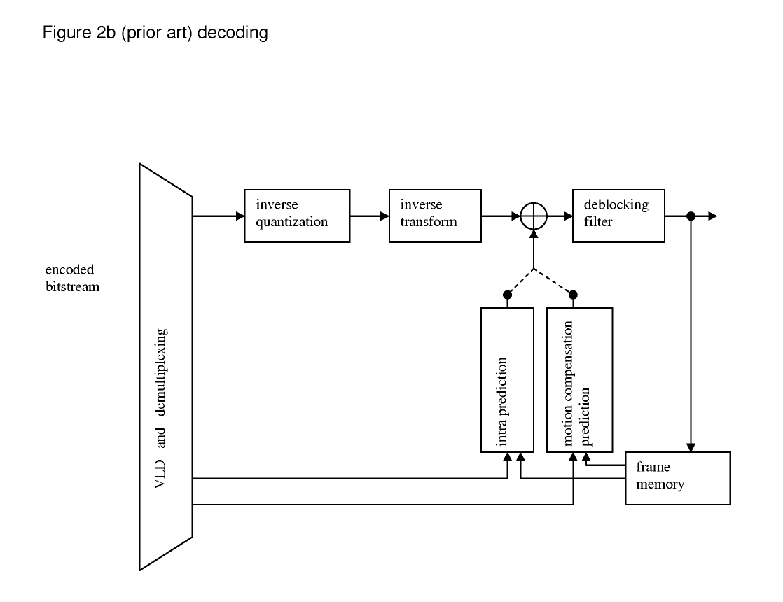

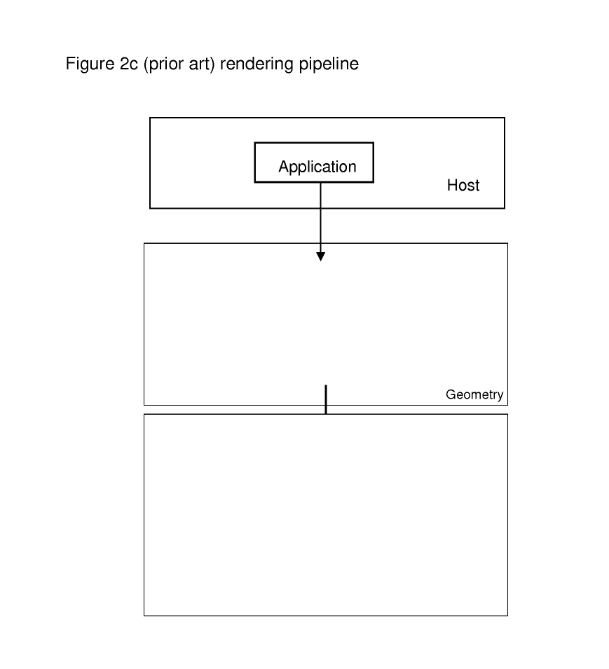

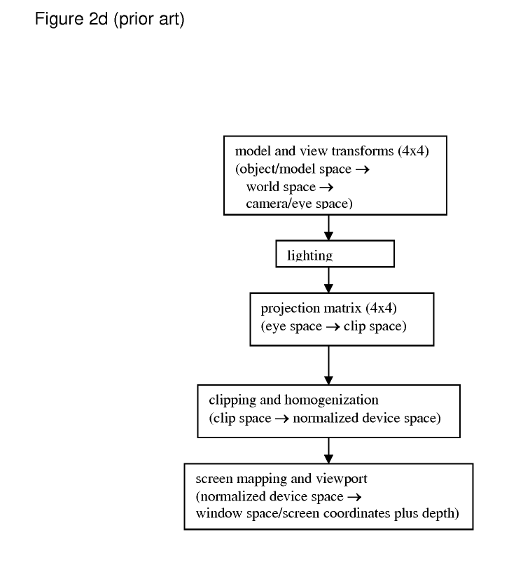

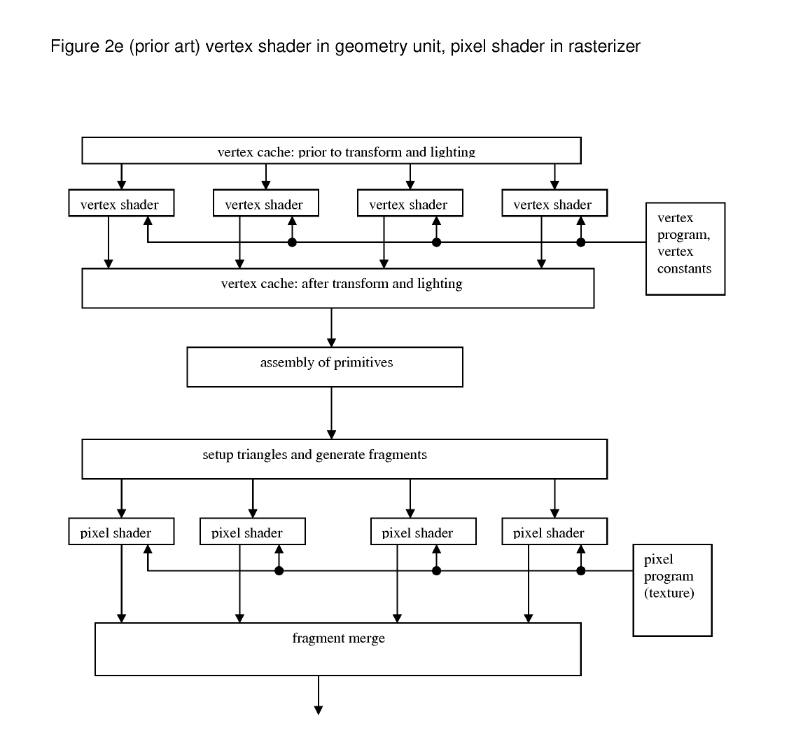

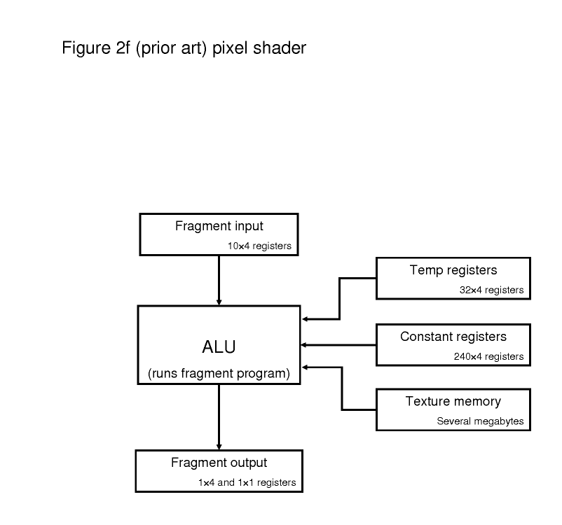

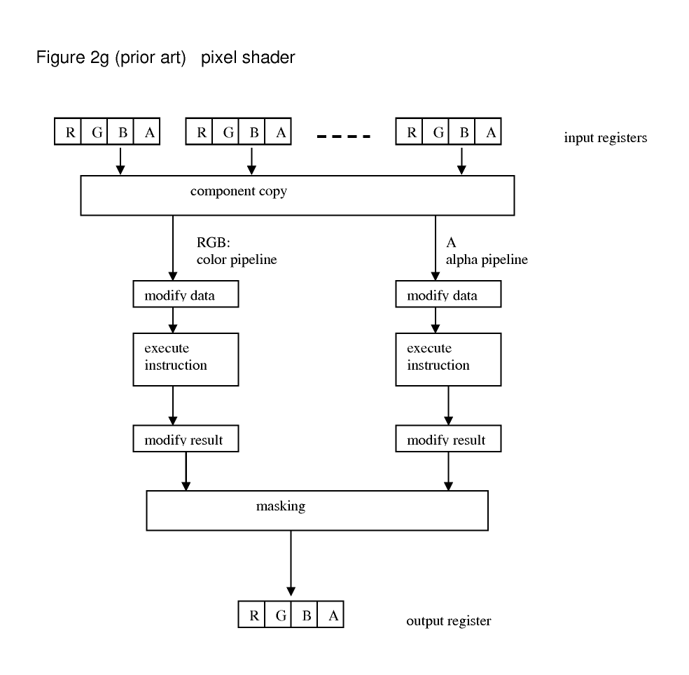

FIGS. 2c-2d shows the two main processing steps involved in a 3D graphics rendering engine: Geometry stage and Rasterizer stage. The geometry stage operates on vertices in the 3D world that describe the scene to be rendered. The basic operations involved in this step are transformation of geometric coordinates and lighting calculations. At the end of geometry processing, we get a set of 2D triangles that result from the projection of 3D world triangles onto the view plane. These 2D triangles are input the rasterizer stage. The main functionality of the rasterizer is to color the pixels that lie inside the received 2D triangles. Several programmable options determine the way in which the pixels that lie inside the triangle should be colored. The preferred embodiments focus on the rasterizer stage because they provide extension to this stage to support video decoding. Hence, we will next describe the rasterizer in more detail.

There are three main steps in the rasterizer:
1) Triangle setup: This stage has three sub processes: (a) Edge equation calculation: Using the attribute values at the vertices, edge equations are calculated for the various attributes required for rendering the pixels inside the triangle. (b) xy-rasterization: Using the edge equations, the pixels that reside inside the triangle are determined. (c) Attribute interpolation: Attribute values of pixels inside the triangle are calculated using the attribute edge equations.
2) Pixel shader: This forms the core part of processing in the rasterizer. The next subsection describes it in more detail. The pixel shader operates independently on all pixels within the triangle. Pixel shaders are also referred to as fragment programs. In 3D graphics literature, a fragment denotes a pixel and its related state information (e.g. attributes). We will use the terms pixel shaders and fragment programs interchangeably.
3) Framebuffer operations: In this stage, various operations such as depth testing, alpha testing, et cetera are carried out on the pixel to determine if the pixel can be displayed on the screen or not.
   FIGS. 2f-2g show a generalized pixel shader architecture based on Microsoft Pixel Shader 3.0. The pixel shader operates independently on all fragments inside of a triangle. The core of the pixel shader consists of an ALU that processes the fragment input and outputs the fragment color. The ALU is a vector processor that operates on 4×1 vectors. The ALU instruction set consists of instructions such as vector add, multiply, multiply-accumulate, dot product, et cetera. The ALU has access to two kinds of registers: temporary registers and constant registers. The temporary registers hold intermediate value and have read-write access within a fragment program. The constant registers hold relevant 3D engine state information required by the pixel shader; rhey provide read-only access to the pixel shader. In practice, the contents of the constant registers remain constant for all triangles within a 3D model. They change only when the 3D graphics rendering options are changed at a higher level by using OpenGL or Direct3D. The pixel shader ALU also has access to the texture memory to do texture lookups involved in the calculation of output fragment color. The texture memory is typically several megabytes long. The maximum supported pixel shader program length is at least 512 (this limit is increasing with newer generations of graphics processors). The pixel shader program can have loops and conditional statements.

In most of the current video coding standards, video is encoded using a hybrid Block Motion Compensation (BMC)/Discrete Cosine Transform (DCT) technique. FIGS. 2a-2b illustrate the H.264/AVC standard video coder configuration which uses hybrid BMC plus an integer-approximation DCT. Pictures are coded in either intraframe (INTRA) or interframe (INTER) mode, and are called I-frames or P-frames, respectively. For intracoded I-frames, the video image is encoded without any relation to the previous image, whereas for interceded P-frames, the current image is predicted from the previous reconstructed image using BMC, and the difference between the current image and the predicted image (referred to as the residual image) is encoded. The basic unit of information which is operated on is called a macroblock and is the data (both luminance and chrominance) corresponding to a block of 16×16 pixels. Motion information, in the form of motion vectors, is calculated for each macroblock in a P-frame.

Depending upon the mode of coding used, a macroblock of either the image or the residual image is split into blocks of size 8×8, which are then transformed using the DCT. The resulting DCT coefficients are quantized, run-length encoded, and finally variable-length coded (VLC) before transmission. Since residual image blocks often have very few nonzero quantized DCT coefficients, this method of coding achieves efficient compression. Motion information is also transmitted for the interceded macroblocks. In the decoder, the process described above is reversed to reconstruct the video signal. Each video frame is also reconstructed in the encoder, to mimic the decoder, and to use for motion estimation of the next frame.

When we consider MPEG-4 video decoding, the main steps involved are:

1. Variable length decoding,

2. Inverse quantization,

3. Inverse DCT,

4. Motion compensation.

Operations such as inverse quantization and inverse transform are well suited for vector processing. Also, we shall show in the next section that the operations involved in motion compensation are very similar to those that happen during texture lookup. Hence the pixel shader architecture in FIGS. 2f-2g can be modified to efficiently support video decoding operations. Call the extended pixel shader, a pixel block shader.

FIG. 1 shows the block diagram of video decoder using pixel block shading. The input video bitstream is first processed to decode picture and slice headers. Variable length decoding (VLD) is then done to obtain the transformed coefficients for a macroblock. Operations such as AC/DC prediction that depend on the neighboring blocks are also carried out at this stage. After the macroblock data has been reconstructed, we obtain six 8×8 blocks of video data for each macroblock. Each of these blocks of video data is passed through the pixel block shader to obtain the corresponding reconstructed block of video. The pixel block shader carries out inverse quantization, inverse DCT, and motion compensation steps.

The similarities between FIGS. 1 and 2f are evident. The pixel block shader is a unified architecture that can be used for both 3D graphics rendering and video decoding. When used for 3D graphics, the pixel block shader operates on individual fragments in a triangle. When used for video decoding, the pixel block shader operates on 8×8 blocks of video data present in a video frame. This is graphically depicted in FIG. 4.

### 3. Preferred Embodiment Pixel Block Shaders

Preferred embodiment pixel block shader architectures extend that of pixel shaders (e.g., FIGS. 2f-2g) to be suitable for use in video decoding as follows.

(i) Data Types:

The data types supported in pixel shaders depend upon the vendor who provides the graphics processors. Nvidia supports “half”, float, and double data types. Data type “half” is a 16-bit floating point data type and is sufficient for processing involved in video decoding. Thus a preferred embodiment pixel block shader does not need new data types.

(ii) Input Registers:

Microsoft pixel shader 3.0 (ps_{—}3_{—}0) has 10 4×1 input registers to hold the input fragment data information. For video decoding we need the following input registers:

| | |
|---|---|
| 16 | 4 × 1 registers for block data (8 × 8 block has 64 elements) |
| 1 | 2 × 1 register for quantization parameter (dc and ac qp's) |
| 1 | 2 × 1 register for motion vectors (x- and y- components) |
| 1 | 1 × 1 register for mode information |

Hence the size of input register set increases for a preferred embodiment pixel block shader.

(iii) Output Registers:

Microsoft ps_{—}3_{—}0 supports one or more 4×1 output registers. For video decoding, we require 16 4×1 registers to hold the reconstructed block of video data. Hence, the size of the output register set potentially increases for a pixel block shader.

(iv) Temporary Registers:

Microsoft ps_{—}3_{—}0 supports 32 4×1 temporary registers. For video decoding, we require 32 4×1 registers to store intermediate results during transforms and motion compensation. Hence, the size of temporary register set does not increase for a pixel block shader.

(v) Constant Registers:

Microsoft ps_{—}3_{—}0 supports 240 4×1 constant registers. For video decoding, we require no more than 32 4×1 constant registers (which are mainly to store IDCT matrix coefficients) for video decoding. Hence, the size of constant register set does not increase for a pixel block shader.

(vi) New Instruction for Efficient Inverse Quantization:

The preferred embodiment pixel block shader provides a new instruction—cmpz—that is used during the inverse quantization process. First consider the core computation in inverse quantization in MPEG-4 video decoding which is of the following form:

if(qcoeff[i] != 0)
qcoeff[i] = 2*quantizer_scale*qcoeff[i] +

((qcoeff[i]>0)?quantizer_scale:-quantizer_scale);

else
qcoeff[i] = 0;

In the foregoing, qcoeff is the input 8×8 block of video data. Multiplication by quantizer_scale inverts the quantization procedure carried out in the encoder. The index i varies over the elements of the input block from the range 1 to 63. Microsoft ps_{—}3_{—}0 instructions relevant for implementing inverse quantization are:
1. Instruction: add dst, src0, src1
Operations carried out:

dst.x=src0.x+src1.x;

dst.y=src0.y+src1.y;

dst.z=src0.z+src1.z;

dst.w=src0.w+src1.w;

The vector element referencing notation is as follows: x indicates the 0^{th} element, .y indicates the 1^{st} element, .z indicates the 2^{nd} element, and .w indicates the 3^{rd} element of a vector (i.e., homogeneous coordinates).

2. Instruction: mul dst, src0, src1

Operations carried out:

dst.x=src0.x*src1.x;

dst.y=src0.y*src1.y;

dst.z=src0.z*src1.z;

dst.w=src0.w*src1.w;

3. Instruction: cmp dst, src0, src1, src2

Operations carried out:

dst.x=src1.x if src0.x>=0
src2.x otherwise

dst.y, dst.z, dst.w are calculated in a similar fashion. Here is a code snippet that implements inverse quantization

;r20 contains 2*quantizer_scale
;r21 contains quantizer_scale
;r22 contains −quantizer_scale
;r30 contains 0
;r31 contains 1
;v1 contains e.g. qcoeff[4..7],

| | |
|---|---|
| mul r1, v1, r20 | ;qcoeff[i]*2*quantizer_scale |
| cmp r2, v1, r21, r22 | ;r2[i] = quantizer_scale if qcoeff[i]>=0 |

; = −quantizer_scale otherwise

add r3, r1, r2

;qcoeff[i]=qcoeff[i]*2*quantizer_scale+r2

;Zero-out elements of updated qcoeff[i] that were zero at the
;beginning

| | |
|---|---|
| cmp r10, v1, r30, r31 | ;r10 contains 0 in locations where v1 >=0 |

;and 1 in other locations

| | |
|---|---|
| sub r11, r30, v1 | ;r11 contains −v1 |

| cmp r12, r11, r30, r31 | ;r10 contains 0 in locations where − |
|---|---|
| v1>=0 | |
| | ;and 1 in other locations |
| add r13, r10, r11 | ;r13 contains 0 in locations where |
| v1==0 | |
| | ;and 1 in other locations |
| mul r14, r13, r3 | ;Zeros out elements of updated |
| qcoeff[i] | |
| | ;that were zero in the beginning |

Preferred embodiment pixel block shaders provide a new instruction to carry out the final step in inverse quantization:

New instruction: cmpz dst, src0, src1, src2

Operations carried out:

dst.x=src1.x if src0.x==0
src2.x otherwise

dst.y, dst.z, dst.w are calculated in a similar fashion.

By introducing the instruction cmpz we save about 50% of the cycles in the inverse quantization stage. Using the existing ps_{—}3_{—}0 instruction set would require 5 instructions—cmp, sub, cmp, add, mul—to implement cmpz. In the above code snippet instead of the last 5 instructions we would have:

| | |
|---|---|
| cmpz r4, v1, r30, r3 | ;New instruction in pixel block shader |
| | ;Zero-out elements of updated qcoeff[i] |
| | ;which were zero at the input |

(vii) Modification to Texture Lookup to Support Motion Compensation:

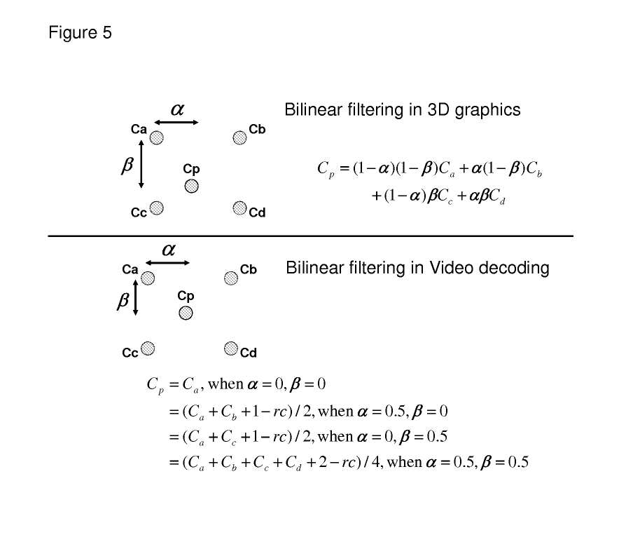

Texture lookup in 3D graphics is one of the most computationally intensive parts in 3D graphics. Our aim is to modify the hardware used for texture lookup so that motion compensation can also be done on it. At a high level, texture lookup and motion compensation carry out very similar steps. In the case of texture lookup, the texture coordinate pair (s, t) provides the (row, column) address for the texture value (texel) to be read from the texture memory. In the case of motion compensation, the motion vector (mvx, mvy) provides the (row, column) address for the motion compensated pixel to be read from the previous frame buffer. Texture lookup and motion compensation, however, differ in the details. Some of the differences and similarities include:
1. Texture coordinates can be arbitrary fractional numbers, where as motion vectors have half pixel resolution (or quarter pixel resolution in some video coders).
2. To sample the texture at fraction pixel locations, texture lookup can be done using one of the several interpolation techniques—nearest, bilinear filtering, and trilinear filtering. Motion compensation, however, uses only bilinear interpolation.
3. Texture clamping at the texture boundary takes care of picture padding that needs to be done for motion compensation when the motion vector points outside the picture.
FIG. 5 shows the bilinear interpolation process in 3D graphics and video decoding. In the figure, Ca, Cb, Cc, and Cd denote the pixel/texel values at integer locations with the upper half of the figure illustrating 3D graphics and the lower half showing video decoding. The value of pixel/texel at the fractional lookup location is denoted by Cp where α and β are the indicated location fractions. The equations to calculate Cp for 3D graphics is:
Cp=(1−α)(1−β)Ca+α(1−β)Cb+(1−α)βCc+αβCd
And for (half-pixel) video decoding:

$$\begin{matrix}Cp = Ca & when α = 0 , β = 0 \\ = ( Ca + Cb + 1 - rc ) / 2 & when α = 0.5 , β = 0 \\ = ( Ca + Cc + 1 - rc ) / 2 & when α = 0 , β = 0.5 \\ = ( Ca + Cb + Cc + Cd + 2 - rc ) / 4 & when α = 0.5 , β = 0.5\end{matrix}$$

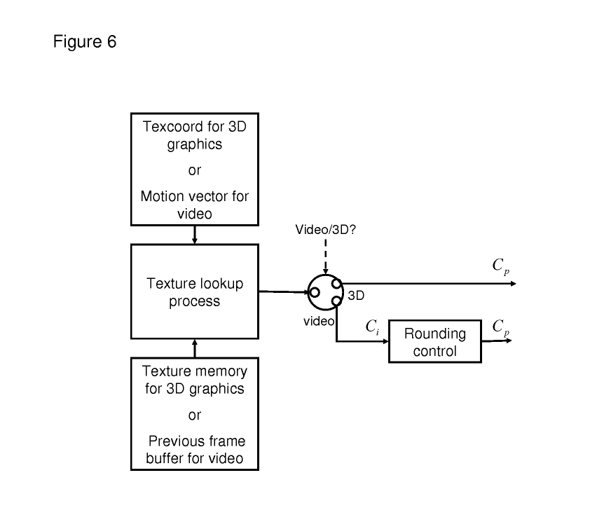

In the case of 3D graphics Cp, Ca, Cb, Cc, and Cd are typically four component vectors consisting of the RGBA values of the texels. In the case of video coding, Cp, Ca, Cb, Cc, and Cd are scalars consisting of luma or chroma values. The value of Cp resulting from bilinear interpolation contains fractional bits. These fractional bits are retained in the case of 3D graphics, whereas in the case of motion compensation, they get rounded or truncated based on the rounding control flag, rc. In the pixel block shader, we modify the texture lookup process to support motion compensation as shown in FIG. 6.

The rounding control block operates on the bilinearly interpolated Ci and outputs Cₚ. The relationship between Cᵢ and Cₚ is given by:
Cₚ=trunc(Cᵢ+rounding_factor)

where rounding_factor depends on rc, α, β, and is given in Table 1 and trunc( ) denotes integer truncation. It can be easily implemented using additional logic. Note that the rounding_factor value remains constant over a block and does not need to be calculated for every pixel in the block.

TABLE 1
rounding_factor values.

| rc | α | β | rounding_factor |
|---|---|---|---|
| 0 | 0 | 0 | 0 |
| 0 | 0 | 0.5 | 0.5 |
| 0 | 0.5 | 0 | 0.5 |
| 0 | 0.5 | 0.5 | 0.5 |
| 1 | 0 | 0 | 0 |
| 1 | 0 | 0.5 | 0 |
| 1 | 0.5 | 0 | 0 |
| 1 | 0.5 | 0.5 | 0.25 |

(viii) Modifications to Texture Read Process:

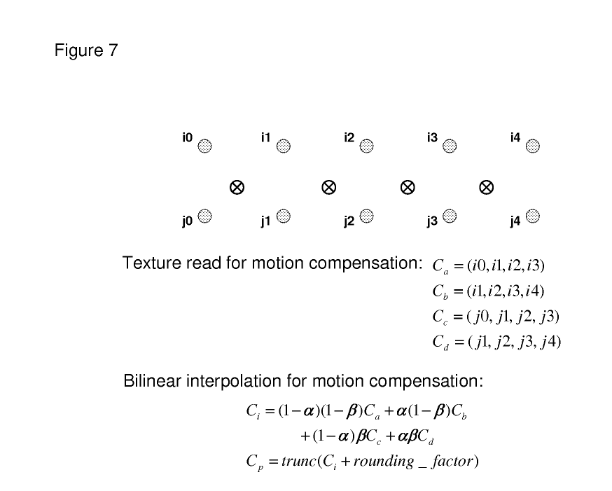

The texture read instruction in Microsoft ps_{—}3_{—}0 returns back a 4×1 vector, the Cp vector of FIG. 5. For the case of video decoding, a pixel block shader maintains compatibility with 3D graphics by vectorizing the motion compensation process to return back four motion compensated pixels. This is done by treating the previous frame buffer as a single component texture (e.g. luminance or alpha texture) and by reading it as a four-component texture (i.e. RGBA texture). FIG. 7 illustrates the vectorization of the motion compensation process for the case of ½ pixel motion vectors with four motion compensation (interpolated) pixels indicated by circled X's and the corresponding integer location pixels values i0, i1, . . . , j4. Then a first 3D graphics read at the address of the i0 pixel gives Ca as (i0, i1, i2, i3). Similarly, a second read at the address of the i1 pixel gives Cb as (i1, i2, i3, i4). Likewise the third and fourth reads give Cc=(j0, j1, j2, j3) and (j1, j2, j3, j4). Then the .x components of Ca, Cb, Cc, and Cd correspond to the integer pixel values to be interpolated for the leftmost motion compensated pixel, the .y components for the middle left motion compensated pixel, and the .z and .w components for the middle right and rightmost pixels, respectively. At the end of the processing, Cp contains these four motion compensated pixels.

Note that a texturing engine already has the bandwidth and capacity to read four texels; hence, vectorizing motion compensation as shown in FIG. 7 does not impose additional load on the texturing engine.

(ix) Modification to Swizzling for IDCT Code Compaction:

The 2D-IDCT operation is given by
x=TXT^{t}
where X is a block of 8×8 input data, T is the 8×8 2D-IDCT transform matrix, and x is the 8×8 output of the IDCT process. Matrix multiplication can be efficiently implemented on vector machines such as pixel shaders. Several fast algorithms are available to implement the 2D-IDCT; but most of them sacrifice data regularity to reduce the total computations involved. On the vector processors, data regularity is equally important and it is usually observed that direct matrix multiplication (which has good data regularity) is the most efficient. There are several ways of performing matrix multiplication—e.g., by using dot products of rows and columns, by taking linear combinations of rows, or by taking linear combinations of columns. On the pixel shader architecture, we found that taking linear combinations of row is 50% faster when compared to taking dot products. We briefly explain matrix multiplication by taking linear combinations of rows. Consider the matrix multiplication of two 8×8 matrices C and V to yield an 8×8 matrix R=CV where:

$$R = [ \begin{matrix}r 0 & r 8 \\ r 1 & r 9 \\ r 2 & r 10 \\ r 3 & r 11 \\ r 4 & r 12 \\ r 5 & r 13 \\ r 6 & r 14 \\ r 7 & r 15\end{matrix} ] , C = [ \begin{matrix}c 0 & c 8 \\ c 1 & c 9 \\ c 2 & c 10 \\ c 3 & c 11 \\ c 4 & c 12 \\ c 5 & c 13 \\ c 6 & c 14 \\ c 7 & c 15\end{matrix} ] , V = [ \begin{matrix}v 0 & v 8 \\ v 1 & v 9 \\ v 2 & v 9 \\ v 3 & v 11 \\ v 4 & v 12 \\ v 5 & v 13 \\ v 6 & v 14 \\ v 7 & v 15\end{matrix} ]$$

Each of the vector elements c0, c1, . . . , c15, v0, v1, . . . , v15, and r0, r1, . . . , r15 is of the dimension 1×4 (e.g., the first row of C consists of the 8 scalar elements c0.x, c0.y, c0.z, c0.w, c8.x, c8.y, c8.z, c8.w). Thus, vector element r0 is given by r0=c0.x*v0+c0.y*v1+c0.z*v2+c0.w*v3+c8.xtv4+c8.y*v5+c8.z*v6+c8.w*v7 This cleanly translates into the following Microsoft ps_{—}3_{—}0 program which makes use of the mad (multiply and add of 4-vectors) instruction. The mad instruction is given by: mad dst, src0, src1, src2; and it implements dst.x=src0.x*src1.x+src2.x; and analogously for the other three components. The following code segment also makes use of swizzling when reading a source operand. c0.xxxx is a vector whose four components are all equal to c0.x.
Vector element r0 is calculated as follows presuming initialization at 0:
mad r0, c0.xxxx, v0, r0
mad r0, c0.yyyy, v1, r0
mad r0, c0.zzzz, v2, r0
mad r0, c0.wwww, v3, r0
mad r0, c8.xxxx, v4, r0
mad r0, c8.yyyy, v5, r0
mad r0, c8.zzzz, v6, r0
mad r0, c8.wwww, v7, r0
Similarly vector element r1 can be calculated using the following code snippet:
mad r1, c1.xxxx, v0, r1
mad r1, c1.yyyy, v1, r1
mad r1, c1.zzzz, v2, r1
mad r1, c1.wwww, v3, r1
mad r1, c9.xxxx, v4, r1
mad r1, c9.yyyy, v5, r1
mad r1, c9.zzzz, v6, r1
mad r1, c9.wwww, v7, r1

To implement the complete transform, we need 2×16×8=256 instructions. The factor 2 comes about because two matrix multiplications are involved in the transform. Since there is a limit on the number of instructions that can be in the pixel shader program, code compaction becomes important. Code compaction is allowed in Microsoft ps_{—}3_{—}0 by using loops and relative addressing. Register set v's can be addressed using the loop counter. An easy way to loop the above matrix multiplication code is to introduce relative addressing for swizzling operations too. For example, introduce the following relative addressing into swizzling operations:

$$\begin{matrix}c 1. iiii = c 1. xxxx when ( loop\_counter \& 0 \times 3 ) == 0 \\ = c 1. yyyy when ( loop\_counter \& 0 \times 3 ) == 1 \\ = c 1. zzzz when ( loop\_counter \& 0 \times 3 ) == 2 \\ = c 1. zzzz when ( loop\_counter \& 0 \times 3 ) == 3\end{matrix}$$

Using the new addressing mode, the code segment:
mad r0, c0.xxxx, v0, r0
mad r0, c0.yyyy, v1, r0
mad r0, c0.zzzz, v2, r0
mad r0, c0.wwww, v3, r0
can be compacted as:
loop 4 times
mad r0, c0.iiii, v[i], r0
endloop
By grouping several such code segments into the loop, we can achieve 75% code compaction for the 2D-IDCT.

In summary, the foregoing preferred embodiment pixel block shaders (FIG. 1) have an overall architecture analogous to a current pixel shaders (FIG. 2f) and compare as follows:

(i) data types: pixel block shaders can use simple pixel shader data types.

(ii) input registers: pixel block shaders require a large enough input register set to hold a block plus motion vector; this may be larger than a pixel shader input register set.

(iii) output registers: pixel block shaders require a large enough output register set to hold a reconstructed block; this may be larger than a pixel shader output register set.

(iv) temporary registers: pixel block shaders require a large enough temporary register set to hold intermediate results during transforms and motion compensation; this likely will be about the same size as a pixel shader temporary register set.

(v) constant registers: pixel block shaders require a large enough constant register set to hold IDCT matrix coefficients; this likely will be smaller than a pixel shader constant register set.

(vi) instruction set: pixel block shaders perform inverse quantization, so the command cmpz for a zero comparison which is not a standard pixel shader command provides 50% of inverse quantization cycles.

(vii) texture lookup: sub-pixel motion compensation requires bilinear interpolation of pixels in the reference frame. Pixel shader texture lookup provides interpolation, so pixel block shaders use this texture lookup with the reference frame buffer in place of the texture memory. However, motion compensation uses round-off, so pixel block shaders add a rounding operation option to a pixel shader texture lookup output as illustrated in FIG. 6.

(viii) texture read: 3D graphics texture data is 4-vector data, whereas, video coding block data is scalar data. Therefore a pixel block shader vectorizes motion compensation to compute four prediction pixels for each read (texture lookup) from the reference frame buffer.

(ix) code compaction: video decoding has inverse DCT 8×8 matrix multiplications which take 256 pixel shader instructions when using linear combinations of rows format for the matrix multiplication. However, this can be reduced if the pixel shader instructions allow relative addressing and looping. Thus the pixel block shader likely may use current pixel shader instructions for the 8×8 matrix multiplications.

### 4. Modifications

The preferred embodiment pixel block shaders and decoding methods may be modified in various ways while retaining one or more of the features of (i) a pixel shader texture memory adapted to a video reference frame buffer, (ii) pixel shader texture lookup adapted to sub-pixel reference frame interpolation with rounding operation, (iii) inverse quantization simplifying instruction, and (iv) relative addressing for 8×8 matrix multiplication.

For example, other video and image standards, such as JPEG and H.264/AVC, may have different transforms and block sizes, but the same correspondence of 3D graphics and video coding items can be maintained. Indeed, 4×4 transforms only require 4 4×1 registers for block data, so the total number of input registers needed may be less than 10. Further, the decoders and methods apply to coded interlaced fields in addition to frames; that is, they apply to pictures generally.

What is claimed is:

1. A method of video decoding, comprising the steps of:
(a) receiving input motion-compensated video;
(b) providing a pixel shader; and
(c) computing motion compensation for pictures of said video, said computing including texture lookup by said pixel shader.

2. The method of claim 1, wherein:
(a) said pixel shader has a compare to zero instruction for inverse quantization.

3. A decoder for motion-compensated video, comprising:
(a) a pixel shader with texture lookup programmed for motion compensation computations.
